(19) United States
(12) Patent Application Publication
(10) Pub. No.: US 2016/0041633 A1
(43) Pub. Date: Feb. 11, 2016

(54) WIRELESS MOUSE APPARATUS WITH IMPROVED MOUSE WHEEL MODULE

(71) Applicant: Creative Sensor Inc., Taipei City (TW)

(72) Inventors: Jen-Chun WENG, Taipei City (TW); Lun WANG, Taipei City (TW)

(21) Appl. No.: 14/456,206

(22) Filed: Aug. 11, 2014

(51) Int. Cl. G06F 3/0354; G09G 5/00

(52) U.S. Cl. CPC G06F 3/03543; G09G 5/003; G09G 2330/021

(57) ABSTRACT

A wireless mouse apparatus includes a mouse wheel module and an encoder signal processing and induced electromotive force processing circuit. The mouse wheel module includes a mouse wheel, two stator plates, a plurality of coils and a rotation shaft. The mouse wheel includes a multipolar magnetic body. The coils are arranged on the stator plates. The rotation shaft is connected to the mouse wheel and the stator plates. The encoder signal processing and induced electromotive force processing circuit is used for decoding two signals of phase lead or lag produced representative of rotating of the mouse wheel in the two directions of scroll down or scroll up. The encoder signal processing and induced electromotive force processing circuit converts the alternating current induced electromotive forces into direct current induced electromotive forces and then stores in an energy storing apparatus.

### BACKGROUND OF THE INVENTION

1. Field of the Invention

The present invention relates to a wireless mouse apparatus, and especially relates to a wireless mouse apparatus with an improved mouse wheel module.

2. Description of the Related Art

A mouse is a very common electronic apparatus. The mouse can control a screen cursor or a screen scroll. Therefore, the mouse is very important for using a computer.

The mouse can control the screen scroll when a wheel of the mouse is rotated. Currently, the mouse comprises an encoder. The encoder is connected to the wheel of the mouse. By the encoder, the screen scroll is moved upward when the wheel of the mouse is rotated forward. By the encoder, the screen scroll is moved downward when the wheel of the mouse is rotated backward.

However, the cost of the encoder is not cheap and the encoder is broken easily.

Moreover, a wireless mouse needs battery power. The wireless mouse cannot be used when the battery power is low. It is very inconvenient.

### SUMMARY OF THE INVENTION

In order to solve the above-mentioned problems, an object of the present invention is to provide a wireless mouse apparatus with an improved mouse wheel module.

In order to achieve the object of the present invention mentioned above, the wireless mouse apparatus comprises a mouse wheel module and a back end processing module. The back end processing module is electrically connected to the mouse wheel module. The mouse wheel module comprises a mouse wheel, two stator plates, a plurality of coils and a rotation shaft. The mouse wheel comprises a multipolar magnetic body. The mouse wheel is arranged at a midpoint between the stator plates. The stator plates are arranged symmetrically. The coils are arranged on the stator plates. The rotation shaft is connected to the mouse wheel and the stator plates, so that the mouse wheel is rotated opposite to the stator plates. The back end processing module comprises an encoder signal processing and induced electromotive force processing circuit. The encoder signal processing and induced electromotive force processing circuit is electrically connected to the coils. The encoder signal processing and induced electromotive force processing circuit is used for decoding two signals of phase lead or lag produced representative of rotating of the mouse wheel in the two directions of scroll down or scroll up.

Moreover, the mouse wheel further comprises a mouse wheel hole defined at a center of the multipolar magnetic body.

Moreover, the stator plate comprises a stator plate hole defined at a center of the stator plate. The rotation shaft is through the mouse wheel hole and the stator plate holes.

Moreover, the coils are arranged evenly and symmetrically on the stator plates. The coils face the mouse wheel.

Moreover, a quantity of the coils arranged on one of the stator plates is equal to a quantity of the coils arranged on the other stator plate. The quantity of the coils arranged on one of the stator plates is equal to a quantity of magnetic poles of the multipolar magnetic body.

Moreover, the multipolar magnetic body is, for example but not limited to, a cylinder.

Moreover, the magnetic poles of the multipolar magnetic body are arranged evenly.

Moreover, the back end processing module further comprises an energy storing apparatus electrically connected to the encoder signal processing and induced electromotive force processing circuit. The encoder signal processing and induced electromotive force processing circuit converts the alternating current induced electromotive forces into direct current induced electromotive forces and then stores the direct current induced electromotive forces in the energy storing apparatus for supplying power to the wireless mouse apparatus.

Moreover, the wireless mouse apparatus further comprises a mouse base. The stator plates are arranged on the mouse base.

Moreover, the mouse base comprises two support columns for supporting the stator plates.

The efficiency of the present invention is to save the cost of the encoder of the mouse. Moreover, the wireless mouse apparatus of the present invention can self-generate electricity.

### BRIEF DESCRIPTION OF DRAWING

FIG. 1 shows a top view of the wireless mouse apparatus of the present invention.

FIG. 2 shows a partial assembly drawing of the wireless mouse apparatus of the present invention.

FIG. 3 shows a partial exploded view of the wireless mouse apparatus of the present invention.

FIG. 4 shows an embodiment of the magnetic poles on one side of the multipolar magnetic body of the present invention.

FIG. 5 shows the magnetic poles on the other side of the multipolar magnetic body of FIG. 4.

FIG. 6 shows an embodiment of the phase difference of the induced electromotive forces of the coils of the present invention.

### DETAILED DESCRIPTION OF THE INVENTION

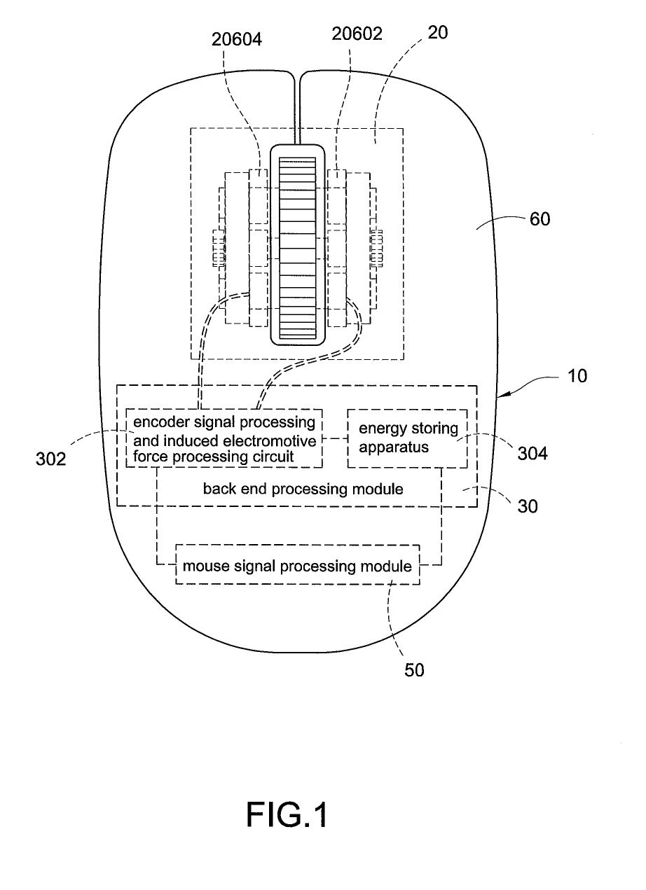

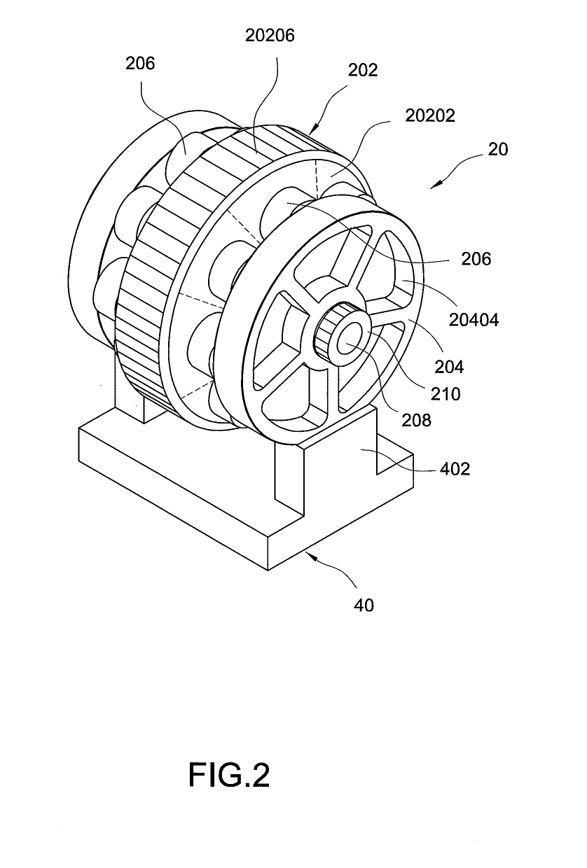

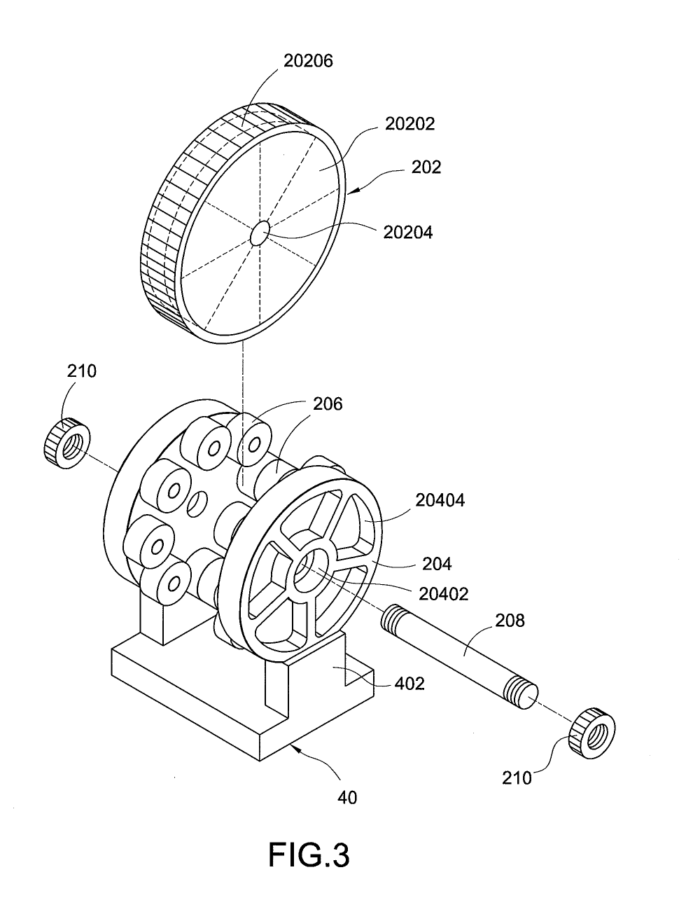

FIG. 1 shows a top view of the wireless mouse apparatus of the present invention. FIG. 2 shows a partial assembly drawing of the wireless mouse apparatus of the present invention. FIG. 3 shows a partial exploded view of the wireless mouse apparatus of the present invention.

A wireless mouse apparatus 10 comprises a mouse wheel module 20, a back end processing module 30, a mouse base 40, a mouse signal processing module 50 and a mouse upper cover body 60.

The mouse wheel module 20 comprises a mouse wheel 202, two stator plates 204, a plurality of coils 206, a rotation shaft 208 and two nuts 210. The back end processing module 30 comprises an encoder signal processing and induced electromotive force processing circuit 302 and an energy storing apparatus 304. The mouse base 40 comprises two support columns 402.

The mouse wheel 202 comprises a multipolar magnetic body 20202, a mouse wheel hole 20204 and a side cover body 20206. The stator plate 204 comprises a stator plate hole 20402 and at least a hollow part 20404.

The mouse wheel 202 is, for example but not limited to, a cylinder. The multipolar magnetic body 20202 is, for example but not limited to, a cylinder. The side cover body 20206 covers a side of the multipolar magnetic body 20202. The mouse wheel hole 20204 is defined at a center of the multipolar magnetic body 20202 (namely, a center of a circle).

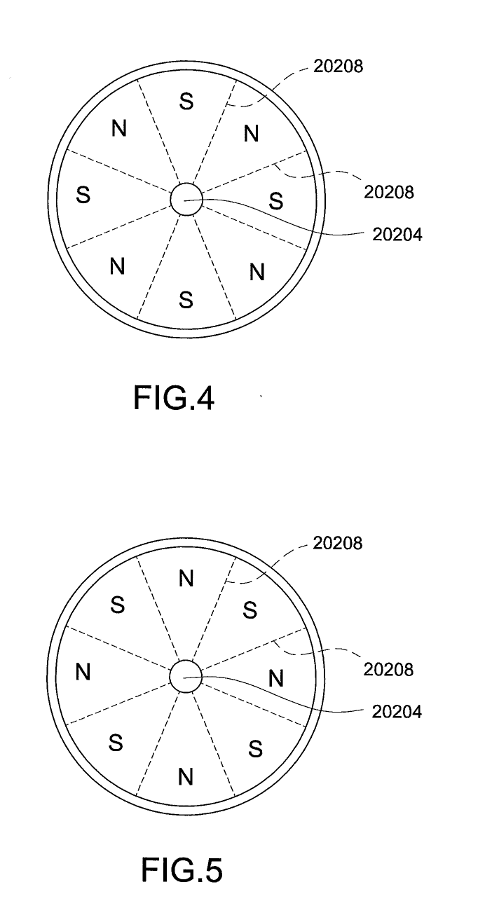

FIG. 4 shows an embodiment of the magnetic poles on one side of the multipolar magnetic body of the present invention. FIG. 5 shows the magnetic poles on the other side of the multipolar magnetic body of FIG. 4. An S pole is adjacent to two N poles, and the other side of the multipolar magnetic body 20202 is an N pole. An N pole is adjacent to two S poles, and the other side of the multipolar magnetic body 20202 is an S pole.

A quantity of the coils 206 arranged on one of the stator plates 204 is equal to a quantity of the coils 206 arranged on the other stator plate 204. The quantity of the coils 206 arranged on one of the stator plates 204 is equal to a quantity of magnetic poles of the multipolar magnetic body 20202.

As shown in FIG. 4 and FIG. 5, at least a cutting line 20208 cuts the center of the circle of the bottom side of the multipolar magnetic body 20202 (namely, the mouse wheel hole 20204), so that the magnetic poles of the multipolar magnetic body 20202 are defined. The magnetic poles of the multipolar magnetic body 20202 are arranged evenly. In another word, angles (intersection angles) formed by the cutting line(s) 20208, which cut the center of the circle of the bottom side of the multipolar magnetic body 20202 (namely, the mouse wheel hole 20204), are equal. For example, as shown in FIG. 4 and FIG. 5, each of the intersection angles is 45 degrees.

The stator plate 204 is, for example but not limited to, a cylinder. The stator plate hole 20402 is defined at a center of the stator plate 204 (namely, a center of a circle). The hollow part 20404 is used to hollow the stator plate 204 to reduce the weight and the cost of the stator plate 204.

The stator plates 204 are arranged on the mouse base 40. The support columns 42 are used for supporting the stator plates 204.

The stator plates 204 are parallel to each other. The stator plates 204 are arranged symmetrically. The mouse wheel 202 is arranged at a midpoint between the stator plates 204. The mouse wheel 202 is parallel to the stator plates 204.

The rotation shaft 208 is a straight rod. The rotation shaft 208 is through the mouse wheel hole 20204 and the stator plate holes 20402. In another word, the rotation shaft 208 is connected to the mouse wheel 202 and the stator plates 204, so that the mouse wheel 202 is rotated opposite to the stator plates 204. The nuts 210 are arranged at two terminals of the rotation shaft 208.

The coils 206 are arranged on the stator plates 204. In an embodiment, the coils 206 are arranged evenly and symmetrically on the stator plates 204. The coils 206 face the mouse wheel 202. For example, in an embodiment, each of the coils 206 faces different magnetic pole of the multipolar magnetic body 20202.

The back end processing module 30 is electrically connected to the mouse wheel module 20. The encoder signal processing and induced electromotive force processing circuit 302 is electrically connected to the coils 208. The energy storing apparatus 304 is electrically connected to the encoder signal processing and induced electromotive force processing circuit 302. The mouse signal processing module 50 is electrically connected to the encoder signal processing and induced electromotive force processing circuit 302 and the energy storing apparatus 304.

The mouse upper cover body 60 covers the mouse wheel module 20, the back end processing module 30, the mouse base 40 and the mouse signal processing module 50 except the mouse wheel 202.

The phase lead or lag of alternating current induced electromotive forces inside the coils 206 is decoded by the encoder signal processing and induced electromotive force processing circuit 302 when the mouse wheel 202 is rotated down or up. The encoder signal processing and induced electromotive force processing circuit 302 converts the alternating current induced electromotive forces into direct current induced electromotive forces and then stores the direct current induced electromotive forces in the energy storing apparatus 304 for supplying power to the wireless mouse apparatus 10.

The mouse signal processing module 50 is used for delivering a corresponding signal (not shown in figures) to a computer (not shown in figures) to control a screen cursor (not shown in figures) or a screen scroll (not shown in figures), and so on.

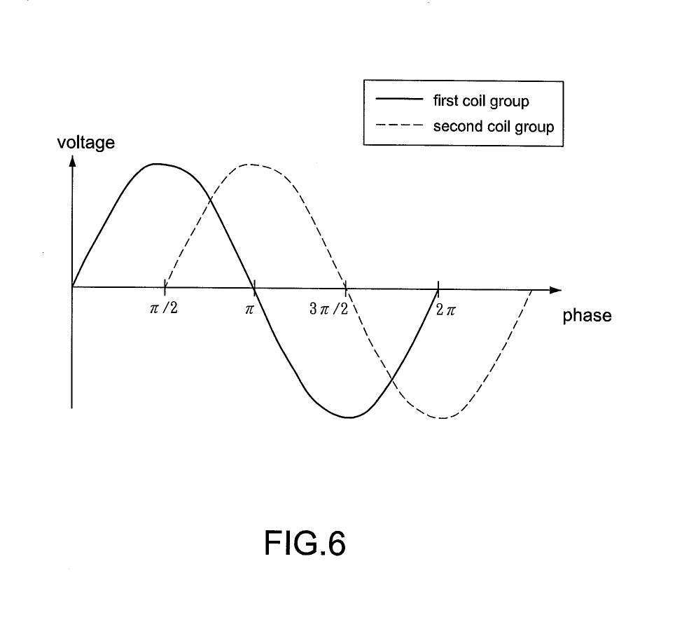

FIG. 6 shows an embodiment of the phase difference of the induced electromotive forces of the coils of the present invention. Please refer to FIG. 1 and FIG. 2 again. A solid line shown in FIG. 6 shows the phase of the induced electromotive forces of the coils 206 arranged on the right stator plate 204 shown in FIG. 1 and FIG. 2 (namely, a first coil group 20602). A dash line shown in FIG. 6 shows the phase of the induced electromotive forces of the coils 206 arranged on the left stator plate 204 shown in FIG. 1 and FIG. 2 (namely, a second coil group 20604).

The rotation direction of the mouse wheel 202 is judged as forwarding to the user when the phase of the induced electromotive forces of the first coil group 20602 leads the phase of the induced electromotive forces of the second coil group 20604. The rotation direction of the mouse wheel 202 is judged as backwarding to the user when the phase of the induced electromotive forces of the second coil group 20604 leads the phase of the induced electromotive forces of the first coil group 20602.

The efficiency of the present invention is to save the cost of the encoder of the mouse. Moreover, the wireless mouse apparatus 10 can self-generate electricity.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wireless mouse apparatus comprising:
a mouse wheel module; and
a back end processing module electrically connected to the mouse wheel module,
wherein the mouse wheel module comprises:
a mouse wheel comprising a multipolar magnetic body;
two stator plates, the mouse wheel arranged at a midpoint between the stator plates, the stator plates arranged symmetrically;
a plurality of coils arranged on the stator plates; and
a rotation shaft connected to the mouse wheel and the stator plates, the mouse wheel rotated opposite to the stator plates,
wherein the back end processing module comprises:
an encoder signal processing and induced electromotive force processing circuit electrically connected to the coils,
wherein the phase lead or lag of alternating current induced electromotive forces inside the coils is decoded by the encoder signal processing and induced electromotive force processing circuit when the mouse wheel is rotated down or up.

2. The wireless mouse apparatus in claim 1, wherein the mouse wheel further comprises a mouse wheel hole defined at a center of the multipolar magnetic body.

3. The wireless mouse apparatus in claim 2, wherein the stator plate comprises a stator plate hole defined at a center of the stator plate; the rotation shaft is through the mouse wheel hole and the stator plate holes.

4. The wireless mouse apparatus in claim 3, wherein the coils are arranged evenly and symmetrically on the stator plates; the coils face the mouse wheel.

5. The wireless mouse apparatus in claim 4, wherein a quantity of the coils arranged on one of the stator plates is equal to a quantity of the coils arranged on the other stator plate; the quantity of the coils arranged on one of the stator plates is equal to a quantity of magnetic poles of the multipolar magnetic body.

6. The wireless mouse apparatus in claim 5, wherein the multipolar magnetic body is a cylinder.

7. The wireless mouse apparatus in claim 6, wherein the magnetic poles of the multipolar magnetic body are arranged evenly.

8. The wireless mouse apparatus in claim 7, wherein the back end processing module further comprises an energy storing apparatus electrically connected to the encoder signal processing and induced electromotive force processing circuit; the encoder signal processing and induced electromotive force processing circuit converts the alternating current induced electromotive forces into direct current induced electromotive forces and then stores the direct current induced electromotive forces in the energy storing apparatus for supplying power to the wireless mouse apparatus.

9. The wireless mouse apparatus in claim 8, further comprising a mouse base, wherein the stator plates are arranged on the mouse base.

10. The wireless mouse apparatus in claim 9, wherein the mouse base comprises two support columns for supporting the stator plates.
